(19) United States
(12) Patent Application Publication
(10) Pub. No.: US 2025/0198697 A1
(43) Pub. Date: Jun. 19, 2025

(54) Heated Work-Extraction Mechanism for a Cryogenic-Based Carbon Dioxide Capture System

(71) Applicant: Southwest Research Institute, San Antonio, TX (US)

(72) Inventor: Douglas Carl HOFER, Clifton Park, NY (US)

(21) Appl. No.: 18/545,358

(22) Filed: Dec. 19, 2023

(51) Int. Cl. F25J 3/06; B01D 53/00; C01B 32/55

(52) U.S. Cl. CPC F25J 3/067; B01D 53/002; C01B 32/55; F25J 3/0695; B01D 2257/504; F25J 2205/20; F25J 2210/70; F25J 2240/02

(57) ABSTRACT

A system for capturing carbon dioxide from an industrial gas as a solidified carbon dioxide. The system is facilitated by a heated work-extraction mechanism which is employed to maintain surfaces of a work extraction mechanism at a temperature sufficient to avoid surface accretion of solidified carbon dioxide thereat. Heat for the work-extraction mechanism may be drawn from circulation of the industrial gas to the work-extraction mechanism through a separate hydraulic network in advance of processing through the work extraction mechanism. Alternatively, a dedicated circulation of a warming fluid may be employed.

### BACKGROUND

Carbon dioxide emissions, particularly from the combustion of fossil fuels and other industrial processes have been identified as potential contributors to environmental issues ranging from local pollution to global climate change. Thus, over the years, various efforts to mitigate and re-capture these emissions have been identified and attempted. For larger industrial processes, particularly where a flue is utilized to facilitate emissions, these efforts may include absorption with amines, adsorption, the use of membranes, calcium looping, biological-focused efforts and even cryogenic efforts.

Cryogenic carbon dioxide capture efforts have proven promising. However, given that efforts are directed at a stream of flue gas, such as through a flue, this means that a flue channel with physical inner walls is exposed to the stream throughout the process. So, for example, cryogenically cooling the flue gas means that the carbon dioxide within the stream will begin to condense as a solid at pressures and temperatures below the triple point at about 5.17 bara and −56.56° C. This effectively facilitates a transition of the carbon dioxide from a gas to a solid state as dry ice. In theory, and in practice, this renders separation and collection of the carbon dioxide from the stream of flue gas as a practical undertaking.

Unfortunately, the described process involves a form of carbon dioxide condensation wherein the dry ice tends to accumulate at the inner walls of the flue. Further, even where other equipment is utilized, such as directing the stream of flue gas through heat exchangers or other equipment still renders a gas stream where condensing carbon dioxide has a tendency to accumulate at sidewalls of the channel utilized to direct the stream. This leads to clogging of the flue or other equipment which then requires system shutdown, maintenance and considerable expense along with loss of production time. Furthermore, utilizing more complex equipment or techniques that are not standard industry practice, may also present a variety of cost and training obstacles. Therefore, while cryogenic carbon capture techniques appear promising, operators often avoid the hassle of implementing such techniques in spite of the promising potential.

### SUMMARY

Embodiments of a cryogenic-based carbon dioxide capture system embodiments are detailed herein. For one embodiment an exhaust line for channeling a gas stream to a work extraction mechanism is taught. The work extraction mechanism may be utilized to cool the gas stream and condense carbon dioxide from the gas stream into a solid form in absence of surface accretion within the system. To this end, the mechanism may include a housing for receiving the gas stream with a moving implement therein. A heating device is coupled to one of the housing and the implement to target one of an interior surface within the housing and the implement to keep temperature thereat above a de-sublimation temperature of the carbon dioxide.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a schematic layout for an embodiment of a cryogenic-based carbon capture system with a heated work extraction mechanism.

FIG. 2 is a perspective view of a turbine assembly embodiment for the work extraction mechanism of FIG. 1.

FIG. 3A is a partial perspective view of an end portion of a blade for the turbine assembly of FIG. 2.

FIG. 3B is a side cross-sectional view of the end portion of the blade of FIG. 3A.

FIG. 4A is a schematic layout for an alternate embodiment of a heated work extraction mechanism facilitated cryogenic carbon capture system.

FIG. 4B is a schematic layout for another alternate embodiment of a heated work extraction mechanism facilitated cryogenic carbon capture system.

FIG. 4C is a schematic layout for yet another alternate embodiment of a heated work extraction mechanism facilitated cryogenic carbon capture system.

FIG. 5 is a flow-chart summarizing an embodiment of utilizing a heated work extraction mechanism facilitated cryogenic carbon capture system.

### DETAILED DESCRIPTION

Embodiments are described with reference to a particular cryogenic-based carbon capture system. Specifically, the embodiments depict a system where work extraction is utilized to condense carbon dioxide from a gas stream. In this manner, obtaining carbon dioxide in solid form may be achieved in a manner that avoids surface accretion. However, other configurations of the system may be utilized. For example, there may be options in utilizing multiple compressors, the extracted carbon dioxide in solid form may be liquified and re-used through the system for continued operation and a host of other system layout possibilities. Regardless, so long as the system achieves carbon-capture with a work extraction mechanism, as opposed to being a surface temperature based reduction, at the time of condensation, appreciable benefit may be realized in the substantial absence of surface accretion.

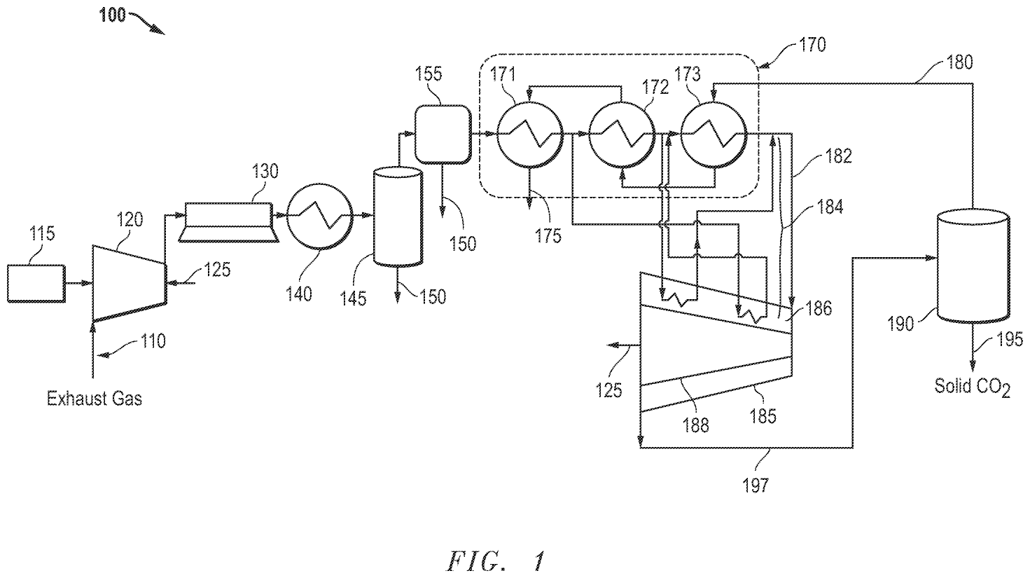

Referring now to FIG. 1, a schematic layout for an embodiment of a cryogenic-based carbon capture system 100 with a heated work extraction mechanism 185 is illustrated. As with many industrial processes, the carbon dioxide gas is a natural byproduct or emission that presents as an exhaust gas 110 to be dealt with. Further, to manage the exhaust 110, it is routed to a compressor 120 that is driven by a driver 115 such as an electric motor to compress the exhaust gas to between about 3 and 10 bara. This type of pressure range may be suitable for promoting carbon dioxide condensation for subsequent capture as described below. Additional power for the compressor 120 may be supplied by a shaft 125. For example, in the illustrated embodiment, some of this power for the shaft 125 may be drawn from a working or “work extraction” mechanism 185 that is utilized in condensing the carbon dioxide of the exhaust 110 into a solid form as detailed further below.

Ultimately, it is the work extraction mechanism 185, such as a turbo-expander, that presents a volumetric effect to the received gas stream to cool and condense without reliance on a cooling surface to achieve the condensation. As a result, condensate or accretion of carbon dioxide is not promoted at system surfaces. Thus, once the stream begins to present as a partially solid carbon dioxide stream 197, clogging or blocking of the flow with buildup is not promoted. Indeed, as illustrated at 195, upon routing through a mechanical separator 190, solid carbon dioxide may be drawn from the system for practical management and removal from the system 100. This leaves a clean emission 180 available for venting or other uses. As used herein, the term “clean” emission is meant only to infer a substantially carbon-free form of emission as is the nature of the system 100.

Continuing with reference to FIG. 1, the work extraction mechanism 185 ultimately receives a processed gas stream from a recuperator 170 as discussed in detail below. The stream enters at a housing which accommodates a moving implement, in this case, a turbine 188. As also discussed below, the entering gas stream will be at a working temperature just above a de-sublimation temperature for any carbon dioxide in the stream. Thus, for the reasons noted above, the use of a work extraction mechanism 185 may promote the formation of carbon dioxide ice through work extraction which substantially avoids accretion of this ice at the moving implement or other housing surface locations. However, to further avoid any such accretion, the work extraction mechanism 185 may also include a targeted heating mechanism as described herein.

For the embodiment of FIG. 1, the targeted heating mechanism utilizes a hydraulic network 184 to circulate the gas stream between the recuperator 170 and the work extraction mechanism 185. More specifically, for the embodiment shown, the portion of the gas stream which has completed its travel through the entirety of the recuperator 170 is shown at 182. However, other portions of the gas stream which have not completed the travel through the entirety of the recuperator 170 are prematurely drawn from the recuperator at a higher temperature and diverted to the extraction mechanism 185 through the hydraulic network 184. Notice that the recuperator 170 for the embodiment depicted is made up of three sequential recuperators 171, 172, 173. This means that as the gas stream is taken down to a working temperature below 0° C., perhaps reaching as low as −120° C. when reaching the work extraction mechanism 185 for processing, it does so in phases. Specifically, at locations between the sequential recuperators 171, 172, 173, the temperature of the gas stream will be above that of the working temperature of the gas stream for processing, −120° C. in the present example. Therefore, as arranged, the network 184 circulates the gas stream above this working temperature to help ensure accretion avoidance within the work extraction mechanism 185.

For the depicted embodiment, this circulation targets reaching a clearance 186 between the turbine 188 and the inner surfaces of the housing 188. Therefore, while the colder portion of the gas stream 182 is delivered to the work extraction mechanism 185 for processing into solid carbon dioxide as described herein, this warmer portion of the gas stream is utilized to target surfaces where accretion might be likely to occur. Of course, there are other types of hydraulic network layout options available as discussed further below which may target heating at the moving implement, interior housing surfaces or other components within the work extraction mechanism. So long as a targeted heating is applied, appreciable benefit may be realized.

Continuing with reference to FIG. 1, from a broader view, the manner in which the exhaust gas 110 is routed through the system 100 and presented to the work extraction mechanism 185 is illustrated in some detail. Individual equipment components and techniques primarily directed at temperature management are utilized so as to present a manageable stream to the work extraction mechanism 185 that is suitable for the formation of solid carbon dioxide that is readily available for capture and extraction. For the embodiment shown, once the compressed stream leaves the compressor 120 it is routed to a first cooling assembly, in this case, an air cooler 130 and a chiller 140 are utilized. The cooling of the stream may take the exhaust gas from an initial mean temperature down to somewhere above about 0° C. Heat from the stream may be rejected to ambient in the process.

Once reaching this initial cooling temperature, the stream may be directed to a mechanical separator 145 where newly formed liquid water 150 may be removed. Additional water 150 may be removed by flowing the stream through a process dryer 155. With water 150 substantially removed, the stream may be directed to a second cooling assembly in the form of a recuperator 170 as noted above. The recuperator 170 may be a heat exchanger where additional cooling may take place down to a working temperature that remains above a de-sublimation temperature for the carbon dioxide in the stream. The use of two-stage cooling allows for the removal of water at a practical temperature short of ice formation followed by additional cooling to facilitate later carbon dioxide solidification.

By this point, just prior to reaching the work extraction mechanism 185 and even with two stages of cooling, the stream remains at a temperature that is still above a condensation temperature for the carbon dioxide, generally between about −80° C. and −120° C., depending on the carbon dioxide concentration in the stream. The cold pressurized stream, still above this condensation temperature for carbon dioxide, may now be directed to the work extraction mechanism 185 described above (see 182). It is of note that when the stream reaches the work extraction mechanism 185, a substantial amount of cooling has already occurred and the stream is within about 10° C.-50° C. of the condensation temperature for the carbon dioxide, perhaps entering at about −110° C. This means that the degree to which the work extraction mechanism 185 is relied upon to achieve the solidification of the carbon dioxide is within a manageable range that does not rely on surface-based temperature reduction to achieve the solidification. As a result, the work extraction which occurs in the mechanism 185 may reasonably attain the necessary condensation temperature of less than about −120° C. without encouraging accretion of solid carbon dioxide at surfaces of the mechanism 185 or anywhere else within the system 100 for that matter. The use of targeted heating as described above may further this avoidance of such surface accretion.

The work extraction mechanism 185 may then be utilized to convert the stream to a partially solid carbon dioxide stream 197. At this point, the stream 197 may be directed to a mechanical separator 190 for separation of the solid carbon dioxide 195 from the stream to achieve the sought carbon capture. The remainder of the stream may be considered a clean emission 180 that is vented or, as illustrated, re-utilized back to the recuperator 170 where the cooled gas may further facilitate the process. Of course, other types of routing for the clean emission 180 may also be incorporated into the layout.

For the embodiment shown, the work extraction mechanism 185 may constitute a dynamic working device such as a condensing turbine. However, a positive displacement device such as a piston or other volumetric affecting device may also be utilized to extract work through a moving boundary as opposed to inducing a dramatic temperature variation in order to achieve the sought degree of de-sublimation for solidifying the carbon dioxide. Indeed, the likelihood is that the boundary surfaces of the moving portions of the work extraction mechanism 185 will actually be warmer than the cooling of the stream. Therefore, accretion of de-sublimating carbon dioxide may actually be discouraged thereby keeping the system 100 substantially free of clogging for sake of continued operation. As noted above, the power available from the work extraction mechanism 185 may also naturally be a candidate for supplementing power to the shaft 125 for further driving the initial compressor 120 or for other supplemental purposes.

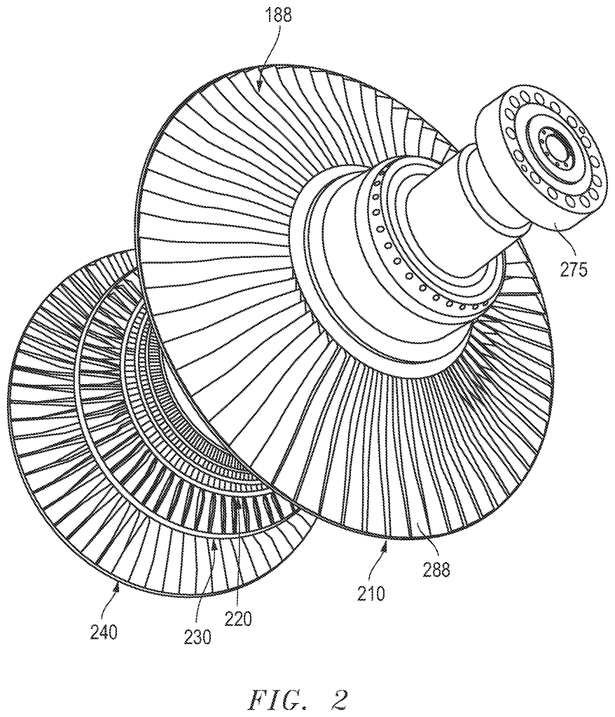

Referring now to FIG. 2, a perspective view of a turbine 188 for the work extraction mechanism of FIG. 1 is shown. For this embodiment, the turbine 188 consists of a series of different blade assemblies 210, 220, 230, 240 that are supported about a central mandrel 275. Each individual blade 288 presents a surface to the interior of the housing 187 of the work extraction mechanism 185 along with other structural components of the mechanism. Thus, these particular surfaces may be targeted for heating as described above so as to further the avoidance of accretion during the described process. That is, throughout the processing of the gas stream, temperature regulation and timing are factors taken into consideration so as to avoid accretion.

The interior of the housing may include various airfoils or blades 288, along with the rest of the turbine 188, along with shrouds above the blades 288, flow-path casings, stationary nozzles and other components. Therefore, avoiding accretion may involve a host of surfaces within the housing that otherwise might be prone to such an occurrence. For the present embodiments, the sequence of temperature applications, followed by use of a work extraction mechanism 185 to complete the carbon dioxide solid transformation avoids this risk, particularly where the mechanism 185 itself employs targeted heating as described herein.

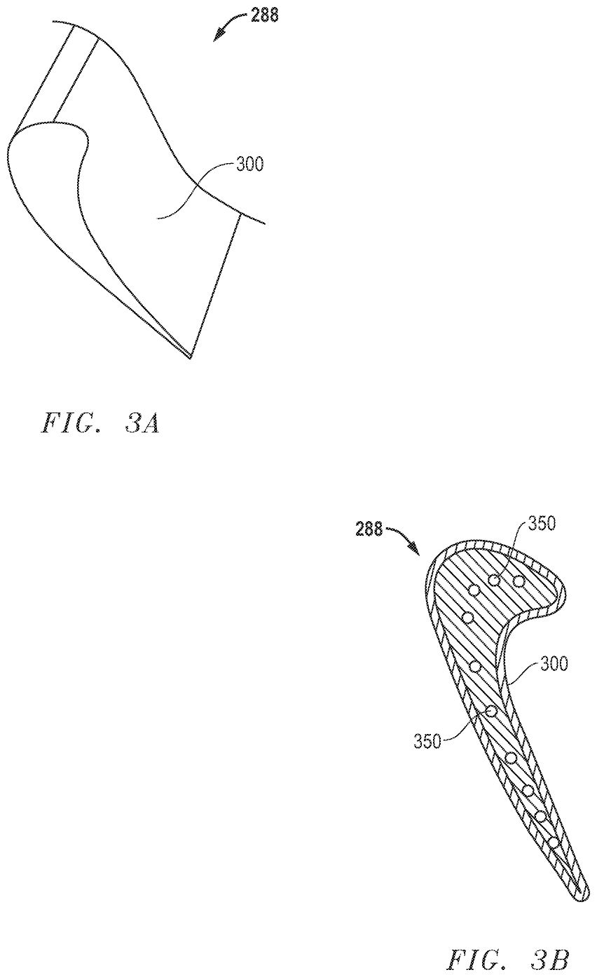

Referring now to FIG. 3A, a partial perspective view of an end portion of the blade 288 for the turbine 188 of FIG. 2 is shown. The blade 288 includes a curved surface 300 which is utilized in the work extraction described above via the turbine 188. However, this surface 300 may have heat directed thereat to further mitigate the possibility of any accretion at the surface 300.

Referring now to FIG. 3B, a side cross-sectional view of the end portion of the blade 288 of FIG. 3A is shown. The cross section reveals a blade embodiment where internal channels 350 are utilized in facilitating the circulation of the gas stream above through the body of the blade 288. This may be achieved through exposure to the clearance 186 of FIG. 1, a location of the mandrel 275 or any number of design options. Regardless, circulating the warmer gas stream from the hydraulic network 184 of FIG. 1 may help to further ensure the avoidance of any accretion at the blade 288.

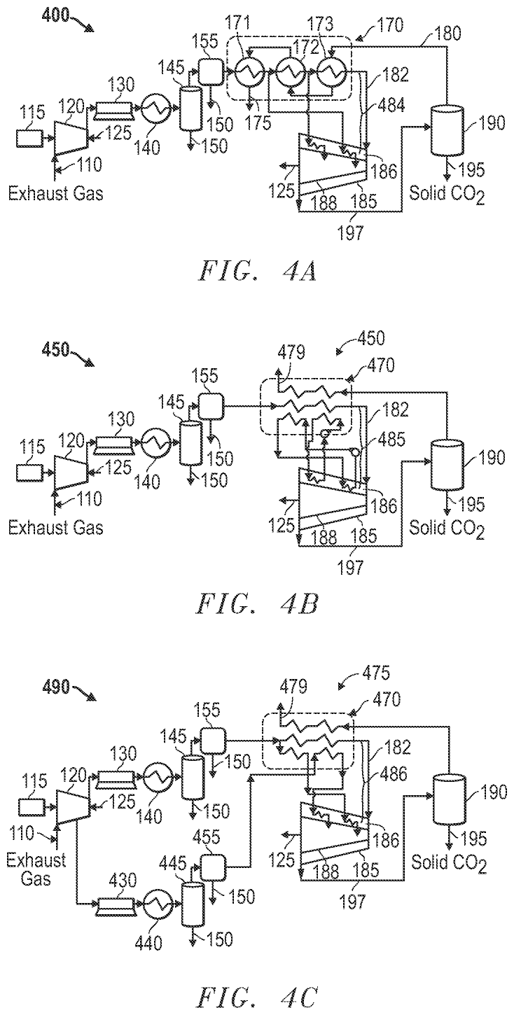

Referring now to FIG. 4A, a schematic layout for an alternate embodiment of a heated work extraction mechanism facilitated cryogenic carbon capture system 400 is shown. Of course, the primary matter of obtaining exhaust gas 110 for extraction of carbon dioxide in solid form 195 remains at issue. To avoid accretion, the system 400 again utilizes a targeted heat work extraction mechanism 185 to complete the carbon dioxide solidification as shown.

Instead of returning the warmer gas stream from premature locations of the recuperator 170, this warmer gas stream is circulated through the turbine 188. Allowing this warmer portion of the gas stream to enter the main flow path may expose more interior components to encounter the effects of this warming fluid. This may be particularly beneficial for the rotating or moving parts of the work extraction mechanism 185. That is, the particular layout of the hydraulic network 484 for this warmer portion of the gas stream may be tailored to the configuration of the work extraction mechanism 185 itself and operator preferences. Regardless, once managed by the mechanism 185, this stream will still exit as a partially carbon dioxide solid stream at 197 for the carbon dioxide present within the stream.

Referring now to FIG. 4B, a schematic layout for another alternate embodiment of a heated work extraction mechanism facilitated cryogenic carbon capture system 450 is shown. For this embodiment, the network 485 layout is similar to that of FIG. 1 (see network 184). However, for this embodiment, the circulation from and back to the recuperator 470 is of a separate dedicated warming fluid that is not intended to merge with the gas stream from which the carbon dioxide is later extracted. As a result, the recuperator 470 may be a multi-pass heat exchanger or other device which presents more of a temperature gradient effect on the gas stream running therethrough. The network 484 in this instance may be arranged to align with the portion of the gas stream and heat exchanger that effects a temperature above the working temperature (e.g. −120° C. in the present examples).

Such a dedicated hydraulic layout may be supported by a circulating device such as a pump and the fluid may be propane or another suitable fluid that remains in liquid form within the temperature range of interest. That is, as described above, the gas stream for processing from the recuperator 470 may reach the work extraction mechanism 185 at a working temperature of between about −80° C. and −120° C. Thus, fluids which may remain in reliably liquid form at such temperatures may be suitable candidates for use in this dedicated circulating network 485. Again, the particular layout of the hydraulic network 485 for this dedicated warming fluid may be tailored to the configuration of the work extraction mechanism 185 itself and operator preferences.

Referring now to FIG. 4C, a schematic layout for yet another alternate embodiment of a heated work extraction mechanism facilitated cryogenic carbon capture system 490 is shown. For this embodiment, the warming fluid is again made up of the gas stream and the layout of the network 486 is similar to that of the FIG. 4A. However, in this instance, the recuperator 470 is a multi-pass heat exchanger and the network 486 draws on a supply of gas stream that reaches the work extraction mechanism 185 at a lower pressure than the initial gas stream 182. For example, note the separate line supply of the gas stream to another air cooler 430, chiller 440, separator 445 and dryer 455. This arrangement allows for the introduction of an intermediate pressure that can minimize the overall compression work that is necessary in ultimately obtaining the dry ice carbon dioxide from the work extraction mechanism 185. Indeed, additional lines and pressures may be employed in this manner to tailor the system 490 based on operator preference.

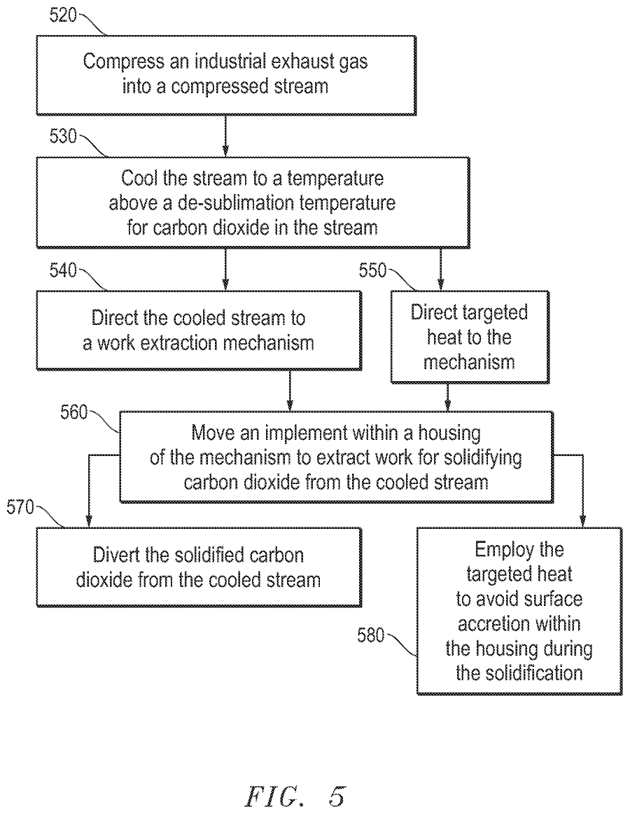

Referring now to FIG. 5, a flow-chart summarizing an embodiment of utilizing a heated work extraction mechanism facilitated cryogenic carbon capture system is shown. As in other circumstances, an industrial exhaust gas is compressed into a stream (see 520). However, at this point, the stream is cooled but to a temperature above a de-sublimation temperature for carbon dioxide in the stream as noted at 530. Rather than completing solidification, the stream is directed to a work extraction mechanism as shown at 540. At the same time, as indicated at 550, a targeted heat is also directed to the work extraction mechanism.

As indicated at 560, the work extraction mechanism may now be utilized to extract work for solidifying carbon dioxide from the stream. Thus, the solidified carbon dioxide may be diverted from the stream (see 570). Further, this occurs with the additional assurance from the targeted heat that surface accretion will not take place at surface locations within the housing of the work extraction mechanism (see 580).

Embodiments described hereinabove include a system and techniques for achieving carbon extraction from an industrial gas through a cryogenic process that avoids accretion of carbon dioxide at system surfaces. Thus, dry ice accumulation at the inner walls of a flue or other channeling is avoided. Additionally, the equipment utilized may be readily available and scalable, industry standard components that do not require a complete re-configuration of system layouts that would be unfamiliar to those in the field. Use of a heated turbine as the primary component for the work extraction mechanism may even present a compact assembly that opens up additional space in the facility footprint. Once more, the addition of amines or other unique chemicals, consumables or process materials is not required as with other carbon extraction methods is not required. Ultimately, a system of familiar industry equipment that is uniquely arranged and includes a work extraction mechanism for the eventual carbon dioxide solidification allows for effective carbon removal from industrial gas without surface accretion and clogging that could lead to the expenses of considerable downtime and/or the need for regular equipment replacement.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

I claim:

1. A cryogenic-based carbon dioxide capture system comprising:
an exhaust line for channeling a gas stream including carbon dioxide gas; and
a work extraction mechanism fluidly coupled to the exhaust gas line to condense the carbon dioxide from the gas stream into a solid form by work extraction and in substantial absence of surface accretion within the system, the work extraction mechanism comprising:
a housing for receiving the gas stream and containing at least one moving implement for extracting work from the gas stream; and
a heating device coupled to one of the housing and the at least one implement to target one of an interior surface within the housing and the at least one implement for maintaining a temperature thereof above a de-sublimation temperature of the carbon dioxide gas to substantially prevent any of the accretion at one of the interior surface and the at least one implement.

2. The cryogenic-based carbon dioxide capture system of claim 1 wherein the work extraction mechanism is one of a dynamic mechanism and a positive displacement mechanism.

3. The cryogenic-based carbon dioxide capture system of claim 2 wherein the dynamic mechanism is one of a condensing turbine and a turbo-expander and the positive displacement mechanism is a piston.

4. The cryogenic-based carbon dioxide capture system of claim 1 wherein the temperature of the gas stream reaching the work extraction mechanism is between about −80° C. and about −120° C.

5. The cryogenic-based carbon dioxide capture system of claim 1 further comprising a recuperator assembly coupled to the exhaust line and the work extraction mechanism for the cooling of the gas stream.

6. The cryogenic-based carbon dioxide capture system of claim 5 further comprising a hydraulic network coupling the heating device to the work extraction mechanism.

7. The cryogenic-based carbon dioxide capture system of claim 6 wherein the heating device is one of the recuperator assembly and a multi-pass heat exchanger.

8. The cryogenic-based carbon dioxide capture system of claim 7 wherein the recuperator assembly comprises sequential recuperating mechanisms with the hydraulic network coupling thereto between the mechanisms.

9. The cryogenic-based carbon dioxide capture system of claim 6 wherein the hydraulic network facilitates a dedicated circulation of warming fluid between the heating device and the work extraction mechanism.

10. The cryogenic-based carbon dioxide capture system of claim 9 wherein the warming fluid is propane.

11. A heated work extraction mechanism for a cryogenic-based carbon dioxide capture system, the mechanism comprising:
one of a turbine assembly and a positive displacement device;
a moving implement within a housing of the mechanism; and
a targeted heating device coupled to the housing to avoid accretion of solid carbon dioxide at surfaces within the housing.

12. The heated work extraction mechanism of claim 11 wherein the implement is one of a turbine blade and a piston.

13. The heated work extraction mechanism of claim 12 wherein the blade comprises one of a curved surface and interior channels for accommodating a warming fluid therein.

14. The heated work extraction mechanism of claim 11 further comprising a hydraulic network between the heating mechanism and the work extraction mechanism.

15. The heated work extraction mechanism of claim 14 wherein the hydraulic network couples to the work extraction mechanism at a clearance between the housing and the turbine assembly.

16. A method of cryogenic-based carbon capture from an exhaust gas stream, the method comprising:
channeling the exhaust gas stream to a work extraction mechanism at a temperature above a de-sublimation temperature for carbon dioxide in the stream;
directing a targeted heat to the work extraction mechanism; and
moving an implement within a housing of the mechanism to cool the stream and solidify carbon dioxide from the stream.

17. The method of claim 16 wherein the channeling of the stream comprises cooling the stream to a temperature above a de-sublimation temperature for carbon dioxide in the stream.

18. The method of claim 16 further comprising utilizing the targeted heat to substantially avoid surface accretion of the solidified carbon dioxide at a surface selected from a group consisting of the implement and an interior surface of the housing.

19. The method of claim 16 further comprising diverting the solidified carbon dioxide from the stream.

20. The method of claim 19 further comprising directing a substantially carbon-free emission away from the diverted solidified carbon dioxide.
